(19) United States
(12) Patent Application Publication
(10) Pub. No.: US 2007/0011861 A1
(43) Pub. Date: Jan. 18, 2007

(54) Cutting method and apparatus and rib electrode for electric discharge machining

(76) Inventors: Yasuhisa Kosuge, Tokyo (JP); Nobuya Ishida, Tokyo (JP)

Correspondence Address: PAUL AND PAUL, 2000 MARKET STREET, SUITE 2900, PHILADELPHIA, PA, 19103, US

(21) Appl. No.: 10/569,048

(22) PCT Filed: Mar. 25, 2005
(86) PCT No.: PCT/JP05/06421

§ 371 Date: Feb. 22, 2006

(30) Foreign Application Priority Data
Mar. 26, 2004 (JP) 2004-093113

(51) Int. Cl. B23P 23/00

(52) U.S. Cl. 29/559; 409/132; 409/293; 409/345; 219/69.11; 219/69.17

(57) ABSTRACT

An object of the present invention is to provide a cutting method and apparatus and a rib electrode for electric discharge machining which can cut a rib portion of a workpiece efficiently and accurately. For this purpose, a cutting tool 11 having cutting edges 23a, 23b extending in parallel or extending along two straight lines diverging toward the forward end in the same plane is prepared. The cutting tool 11 is arranged with respect to a workpiece W such that the two cutting edges 23a, 23b engage with the two opposed side surfaces of the rib portion R of the workpiece W. The cutting tool 11 is moved relative to the workpiece W along a desired machining path, to thereby cut the two side surfaces of the rib portion R of the workpiece W at one time.

### TECHNICAL FIELD

The present invention relates to a cutting method, a cutting apparatus and a cutting tool apparatus suitable for machining the rib portion of a workpiece, and to a rib electrode for electric discharge machining machined by the cutting tool apparatus.

### BACKGROUND ART

A die used for plastic molding or the like is typically cut by an end mill or a ball-end mill. A plastic molded product is often provided with a thin rib or ribs for reinforcement. The rib of the plastic molded product is typically formed as a thin tabular protrusion member having a taper. In the case where the molded product has a thin rib or ribs, the die portion corresponding to the rib is machined by electric discharge using a rib electrode. In the prior art, the rib electrode used for electric discharge machining is fabricated by cutting with a rotary cutting tool such as an end mill or a ball-end mill or by grinding with a grinding wheel.

A method of cutting a workpiece with a non-rotary cutting tool such as a spring-necked turning tool is disclosed in Japanese Patent Publication No. 6-61651. In this machining method, a groove of a rubber die or the like, which is difficult to machine with a rotary cutting tool, is cut using a formed spring-necked turning tool. Also, a device for mounting a rib electrode, for electric discharge machining, on a holder at a position is disclosed in Japanese Unexamined Patent Publication No. 2002-52422. The rib electrode is mounted on this holder at a position by engaging it vertically and horizontally with the holder.

Recently, demand has increased for reducing the weight of industrial products in general, and the rib of plastic molded product is also required to be reduced in thickness. To reduce the rib thickness, the rib electrode used for electric discharge machining of the die is also required to be reduced in thickness. In the case where a thin rib electrode is generated by cutting each side thereof at a time with a rotary cutting tool such as an end mill or a ball-end mill, the deflection or vibration of the rib portion of the workpiece results in a poor machining accuracy and makes the machining difficult. Especially, when a rib electrode having a very high aspect ratio, i.e. the ratio of height to thickness of the rib, is cut with an end mill or a ball-end mill, the resulting deflection or vibration leads to the problem that the cutting load cannot be imposed and the required cutting accuracy is not attained. Also, it is difficult to machine a thin tabular rib electrode for electric charge machining with high accuracy and mount it accurately on an electrode holder. This poses a problem that considerable time is required for the machining and mounting job.

### DISCLOSURE OF THE INVENTION

The present invention is intended to solve these problems of the prior art, and an object of the present invention is to provide a cutting method, a cutting apparatus, a cutting tool apparatus and a rib electrode for electric discharge machining, capable of cutting a rib portion of a workpiece efficiently and accurately.

In order to achieve the object described above, according to the present invention, there is provided a method for cutting a rib portion of a workpiece, which comprises steps of: determining a shape of a cutting edge of a cutting tool so as to be of a shape corresponding to a cross section of a rib portion to be machined; mounting the cutting tool on a spindle of a machine tool; and moving the cutting tool relative to the workpiece along a machining path extending in a direction of the rib portion to be machined to thereby cut the rib portion of the workpiece to a desired shape.

As the shape of the cutting edge of the cutting tool is determined so as to be of a shape corresponding to the cross section of the rib portion to be machined, the rib portion of the workpiece can be cut, one side or both sides at one time, by moving the cutting tool, relative to the workpiece, along the machining path extending in the longitudinal direction of the rib portion.

Also, according to the present invention, there is provided a method for cutting a rib portion of a workpiece, which comprises steps of: preparing a cutting edge of a cutting tool so as to be of a shape corresponding to a cross section of a rib portion to be machined; roughly machining the rib portion of the workpiece with a rotary cutting tool and then mounting the cutting tool on the spindle of the machine tool; and moving the cutting tool relative to the workpiece along a machining path extending in a longitudinal direction of the rib portion to be machined while, at the same time, controlling a rotational angle of the spindle such that the front side of the cutting edge of the cutting tool is always maintained at right angle to the forward direction of the machining path to thereby finish-machine the rib portion to a desired shape with the cutting tool.

If the rib portion is in advance roughly machined by the rotary cutting tool such as an end mill or a ball-end mill and then finish-machined with the non-rotary cutting tool, the machining of the rib portion can be performed efficiently.

Further, according to the present invention, there is provided a cutting apparatus for cutting a rib portion of a workpiece, which includes a spindle for mounting thereon a cutting tool for machining a workpiece; a table for fixing the workpiece thereon; a feed unit for moving the spindle and the table relative to each other; and a cutting tool having a two-pronged cutting edge of a shape corresponding to a cross section of the rib portion of the workpiece to be machined, wherein the two-pronged cutting edge is engaged with both side surfaces of the rib portion to be machined, and the cutting tool is moved relative to the workpiece along a machining path extending in a longitudinal direction of the rib portion to thereby cut the rib portion.

As the two-pronged cutting edge is fed along the machining path extending in the longitudinal direction of the rib portion with the rib portion held at both side surfaces thereof by the two-pronged cutting edge, both side surfaces of the thin rib portion can be cut at one time by the cutting edge while the cutting edge is supporting the thin rib portion on both sides thereof. As a result, the machining can be performed without deflecting or vibrating the thin rib portion. In accordance with the shape of the rib portion, one side of the rib portion may be cut at one time.

Further, according to the present invention, there is provided a cutting apparatus for cutting a rib portion of a workpiece, which includes a cutting tool having a two-pronged cutting edge of a shape corresponding to a cross section of the rib portion of the workpiece to be machined; a spindle for mounting thereon the cutting tool for machining the rib portion of the workpiece and capable of being controlled in rotational angle; a table for fixing the workpiece thereon; and a feed unit for moving the spindle and the table relative to each other in three directions along X-, Y- and Z-axes, wherein the two-pronged cutting edge is engaged with both side surfaces of the rib portion to be machined, and the cutting tool is moved relative to the workpiece along a machining path extending in a longitudinal direction of the rib portion, while at the same time controlling a rotational angle of the spindle such that the front side of the cutting edge of the cutting tool is always maintained at right angle to the forward direction of the machining path, to thereby cut the rib portion.

As the cutting tool having the two-pronged cutting edge is mounted on the spindle in which the rotational angle thereof can be controlled and the cutting tool is moved relative to the workpiece while at the same time controlling the orientation of the cutting edge, to thereby cut the rib portion, the rib portion having a curved shape can be machined easily.

Further, according to the present invention, there is provided a cutting tool apparatus mounted on a machine tool for cutting a rib portion of a workpiece, which includes a shank portion mounted on the machine tool; a cutting portion located axially in front of the shank portion; and a two-pronged cutting edge provided on the cutting portion and extending in a shape corresponding to a cross section of the rib portion to be machined.

If the cutting edge of the cutting tool is prepared so as to of the shape corresponding to the cross section of the rib portion to be machined and the cutting tool is mounted on the spindle of the machine tool to machine the workpiece with the cutting tool, the rib portion can be machined to the same shape as the cutting edge.

Further, according to the present invention, there is provided a cutting tool apparatus mounted on a machine tool for cutting a rib portion of a workpiece, which includes a shank portion mounted on the machine tool; a pair of arms having a fork-shape and located axially in front of the shank portion; and blades mounted on the arms such that an interval and/or angle of the cutting edges can be adjusted in accordance with a cross section of the rib portion to be machined.

According to this cutting tool apparatus, as the shape of the cutting edges is adjusted to machine the workpiece in accordance with the shape corresponding to the cross section of the rib portion to be machined, the machining of the rib portion having various thickness and gradients can be performed.

Further, according to the present invention, there is provided a rib electrode for electric discharge machining mounted on an electrode holder of an electric discharge machine, which includes a base portion having a reference surface for contacting with a reference portion of the electrode holder for holding the rib electrode and mounted on the electrode holder; and a rib portion projected from the base portion and cut by means of a cutting tool having a two-pronged cutting edge of a shape corresponding to a cross section of the rib portion to be machined with reference to the reference surface of the base portion, wherein the shape of the rib portion is roughly machined with a rotary cutting tool and then finish-machined with the cutting tool.

The rib electrode for electric discharge machining is configured of the base portion and the rib portion, and the rib portion is machined integrally with the base portion with reference to the reference surface of the base portion. In the machining of the rib portion, the rib portion is roughly machined with the rotary cutting tool such as an end mill and then finish-machined to the desired size with the cutting tool. The reference surface of the base portion of the rib portion for electric discharge machining machined in this way is brought into contact with the reference portion of the electrode holder of the electric discharge machine and the rib electrode is mounted on the electrode holder.

According to the present invention, as the shape of the cutting edge of the cutting tool is determined so as to be of a shape corresponding to the cross section of the rib portion to be machined and a cutting edge prepared to that shape is used, the rib portion can be machined simply by moving the cutting tool relative to the workpiece along the machining path extending in the longitudinal direction of the rib portion. As compared with the conventional cutting operation using the rotary cutting tool such as an end mill or a ball-end mill, the machining efficiency and the quality of the finished surface are higher. As the cutting edge of the cutting tool is prepared to the shape corresponding to the cross section of the rib portion to be machined, both side surfaces of the rib portion can be cut at one time with the cutting tool having a two-pronged cutting edge. In this case, the thin rib portion is machined while being supported on both sides thereof by the cutting edge. Therefore, the rib portion is not displaced or vibrated, thereby improving the machining efficiency and the machining accuracy. Also, as the shape of the cutting edge can be adjusted, the rib portions having various thickness or gradients can be machined by means of a single cutting tool apparatus. After the rib portion is roughly machined, the interval of the cutting edge can be reduced for finish machining. Therefore, the types of cutting tools to be prepared can be reduced. Further, as the base portion and the rib portion of the rib electrode are machined integrally with each other, the machining accuracy of the rib electrode as a whole is high. Also, as the base portion has the reference surface, the job of mounting the rib electrode on the electrode holder is facilitated.

### BRIEF DESCRIPTION OF THE DRAWINGS

FIGS. 1A to C are diagrams showing a cutting method and a cutting tool apparatus according to a first embodiment of the present invention, in which FIG. 1A is a front view showing the cutting operation as viewed from the front of the cutting tool apparatus, FIG. 1B is a side view of the cutting tool apparatus of FIG. 1A as viewed from a direction indicated by arrow IB, and FIG. 1C is a sectional view of the cutting tool apparatus taken along line IC-IC of FIG. 1A as viewed from a direction indicated by arrow IC.

FIGS. 2A to C are diagrams showing a cutting tool apparatus according to a second embodiment of the present invention, in which FIG. 2A is a front view showing the cutting tool apparatus as viewed from the front of the blades, FIG. 2B is a side view of the cutting tool apparatus of FIG. 2A as viewed from a direction indicated by arrow IIB, and FIG. 2C is a sectional view of the cutting tool apparatus taken along line IIC-IIC of FIG. 2A as viewed from a direction indicated by arrow IIC.

FIG. 3 is a perspective view showing a cutting apparatus according to an embodiment of the present invention.

FIG. 4 is a perspective view of a workpiece including a rib portion curved in an S-shape.

FIG. 5 is a perspective view of a rib electrode for electric discharge machining having two rib portions erected in parallel.

### BEST MODE FOR CARRYING OUT THE INVENTION

Preferred embodiments of the present invention will be described below with reference to the accompanying drawings.

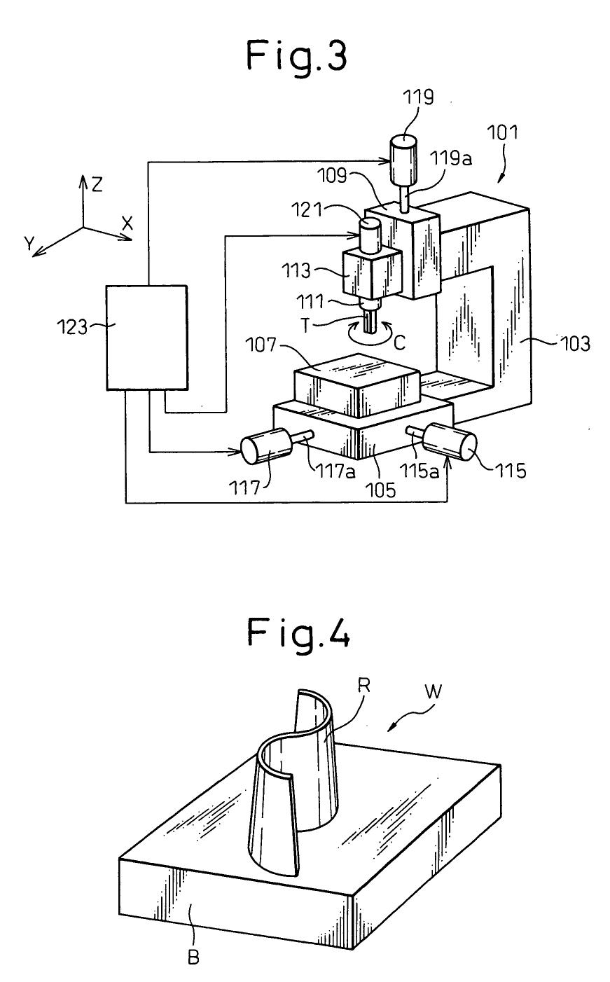

First, a cutting apparatus according to an embodiment of the present invention will be described with reference to FIG. 3. The cutting apparatus 101 includes, as main components, a column 103, an X-Y feed mechanism 105 located on the front side of the lower portion of the column 103, a table 107 located on the X-Y feed mechanism 105 for fixing a workpiece, a Z-axis feed mechanism 109 located on the front side of the upper portion of the column 103, and a spindle head 113 mounted on the Z-axis feed mechanism 109 for rotatably supporting a spindle 111.

The X-Y feed mechanism 105 includes X-axis and Y-axis feed shafts 115a, 117a constituted by ball screws extending in directions along X-axis and Y-axis orthogonal to each other in a horizontal plane, nuts (not shown) located on a lower surface of a table 107 and adapted to engage with the X-axis and Y-axis feed shafts 115a, 117a, and X-axis and Y-axis feed motors 115, 117 constituted by servo motors coupled to one end of each of the X-axis and Y-axis feed shafts 115a, 117a. The Z-axis feed mechanism 109 includes a Z-axis feed shaft 119a constituted by a ball screw extending in a direction along Z-axis orthogonal to X- and Y-axes, a nut (not shown) located on the spindle head 113 and adapted to engage with the Z-axis feed shaft 119a, and a Z-axis feed motor 119 constituted by a servo motor coupled to one end of the Z-axis feed shaft 119a.

The spindle 111 is supported on the spindle head 113 so as to be rotatable in a direction along C-axis about a center axis extending parallel to Z-axis. In this specification, a rotational feed axis about the center axis of the spindle 111 is defined as C-axis. The spindle 111 is supported on the spindle head 113 such that the forward or lower end thereof faces the table 107. The rear or upper end of the spindle 111 is coupled with the C-axis feed motor 121 constituted by a servo motor for controlling the C-axis rotational position of the spindle 111. At the forward end of the spindle 111, a tool fixing means (not shown) for mounting and fixing a cutting tool T described later is provided. The tool fixing means includes a tapered hole formed at the forward end of the spindle 111, and a draw bar for pulling the cutting tool T into the tapered hole. The tool fixing means may be constituted by a tool chuck device provided at the forward end of the spindle 111.

The X-axis, Y-axis and Z-axis feed motors 115, 117, 119 and the C-axis feed motor 121 are connected to a NC unit 123 of the machine tool 101. In accordance with machining program stored in the NC unit 123, the X-axis, Y-axis and Z-axis feed motors 115, 117, 119 and the C-axis feed motor 121 are controlled, so that the cutting tool T mounted on the spindle 111 and the workpiece fixed on the table 107 are moved relative to each other thereby to machine the workpiece to the desired shape.

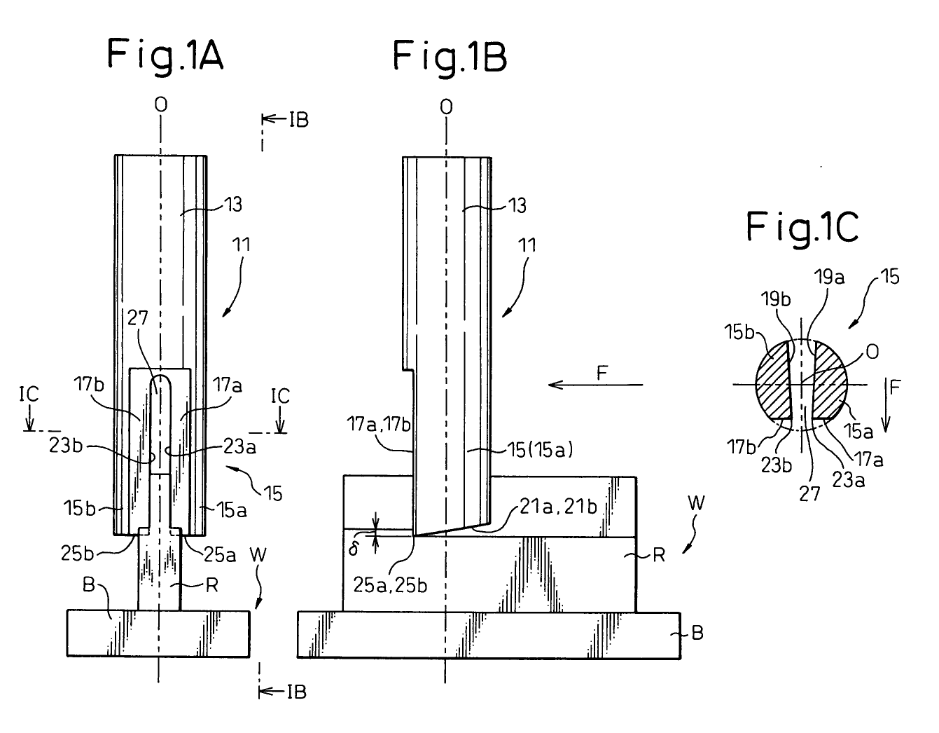

Next, with reference to FIGS. 1A to 1C, a cutting tool apparatus according to a first embodiment of the present invention will be described. In FIGS. 1A to 1C, a cutting tool 11 according to a first embodiment includes a shank portion 13 mounted at the forward end of the spindle 111 of the machine tool 101, and a cutting portion 15 located axially forward of the shank portion 13, i.e. in the lower part of FIGS. 1A and 1B. In this embodiment, the shank portion 13 is formed of a column member or preferably a cylindrical member extending along the center axis O. The cutting tool 11 is mounted at the forward end of the spindle by fixing the shank portion 13 to the spindle 111 by means of the tool fixing means described above. In the process, the center axis O of the cutting tool 11 is preferably coincident with the center of the C-axis of the cutting apparatus 101.

In this embodiment, the cutting portion 15 has a fork-like shape so as to extend axially from the shank portion 13 with an axially extending slit 27 therebetween. The fork-like shape includes a pair of arms 15a, 15b, which are formed with rake faces 17a, 17b formed by cutting off in the same plane parallel to the center axis O of the cutting tool 11. These rake faces may be formed at an appropriate rake angle. In this specification, a face including the rake faces 17a, 17b is defined as a front face of the cutting tool 11. The cutting tool 11 is moved in a direction indicated by arrow F shown in FIG. 1B thereby to cut the rib portion R of the workpiece W. As shown in FIG. 1B, the rake faces 17a, 17b are formed at a position shifted forward of the center axis O. However, the rake faces 17a, 17b are more preferably formed at a position coincident with the center axis O, because the rotational position of the spindle around the C-axis can be controlled more easily.

Referring to FIG. 1C, first flanks 19a, 19b diverging progressively rearward from the rake faces 17a, 17b by the slit 27 are formed on the inner surfaces of the arms 15a, 15b, respectively. The rake faces 17a, 17b and the first flanks 19a, 19b form first cutting edges 23a, 23b on the arms 15a, 15b, respectively. The first cutting edges 23a, 23b extend linearly in parallel to each other or extend linearly or curvedly in such a manner as to gradually diverge from the base end side toward the forward end side, i.e. from the shank portion 13 side toward the forward end of the arms 15a, 15b along the center axis O. The first cutting edges 23a, 23b are formed in a fork-like shape in opposed relation to each other.

Further, referring to FIGS. 1A an 1B, the forward ends of the arms 15a, 15b are formed with second flanks 21a, 21b, respectively. The rake faces 17a, 17b and the second flanks 21a, 21b form the second cutting edges 25a, 25b at the forward ends of the arms 15a, 15b, respectively. In this embodiment, the second cutting edges 25a, 25b extend along the same straight line perpendicular to the center axis O as viewed from the front side of the cutting tool 11.

On the other hand, in FIGS. 1A and 1B, the workpiece W includes a tabular base portion B fixed directly or indirectly through a pallet on the table 107 of the machine tool 101, and a rib portion R formed of a thin plate linearly projected from the upper surface of the base portion B. The two opposed side surfaces of the rib portion R are roughly machined (pre-machined) by an end mill or a ball-end mill to substantially the same shape as the end product so as to extend in parallel or with a gradient progressively converging toward the forward end.

An operation of this embodiment and a cutting method according to the present invention will be described below. The shank portion 13 of the cutting tool 11 is mounted at the forward end of the spindle 111 of the cutting apparatus 101. When the cutting process is started, the cutting tool 11 is located at a machining start position, i.e. at the upper right corner of the rib portion R in FIG. 1B, by means of X-axis, Y-axis, and Z-axis feed mechanisms 105, 109 of the cutting apparatus 101. The first cutting edges 23a, 23b and the second cutting edges 25a, 25b of the cutting tool 11 engage the two side surfaces of the rib portion R. At the same time, the second cutting edges 25a, 25b engage with the side surfaces by a predetermined cut depth 8 in the direction along Z-axis, and the cutting tool 11 is fed in a cutting direction F along a machining path extending in a longitudinal direction of the rib portion R. As a result, the two side surfaces of the rib portion R are cut thinly, and at one time, by the first cutting edges 23a, 23b. When the first cutting edges 23a, 23b and the second cutting edges 25a, 25b arrive at the left edge of the workpiece W, the cutting tool 11 is moved up along Z-axis and fed to the right edge of the workpiece W. Then, the cutting tool 11 is fed in the direction along Z-axis by the cut depth δ with respect to the machining surface previously machined, and then fed again in the cutting direction F. By repeating this process, the rib portion R of the workpiece W is cut little by little from the upper portion to the lower portion in FIG. 1B.

As described above, in this embodiment, the cutting tool 11 is arranged with respect to the workpiece W such that the first cutting edges 23a, 23b engage the two opposed side surfaces of the rib portion R. Then, the two side surfaces of the rib portion R are cut at one time by moving the cutting tool 11 relative to the workpiece W along the desired machining path (in this embodiment, along the linear or curved machining path extending in the longitudinal direction of the rib portion R). Thus, the two side surfaces of the rib portion R being cut are, as shown in FIG. 1A, supported in opposite directions by the two first cutting edges 23a, 23b of the cutting tool 11. Therefore, stable machining can be performed without deflecting or vibrating the rib portion R during the machining process. According to this cutting method, if the aspect ratio, i.e. the ratio of the rib height to the thickness of the forward end of the rib portion is 10 to 200, the rib portion can be machined. For example, even a workpiece of graphite having a thickness of 1 mm at the forward end of the rib, a rib height of 100 mm, a rib length of 80 mm and an aspect ratio of 100 can be machined with high efficiency and high accuracy.

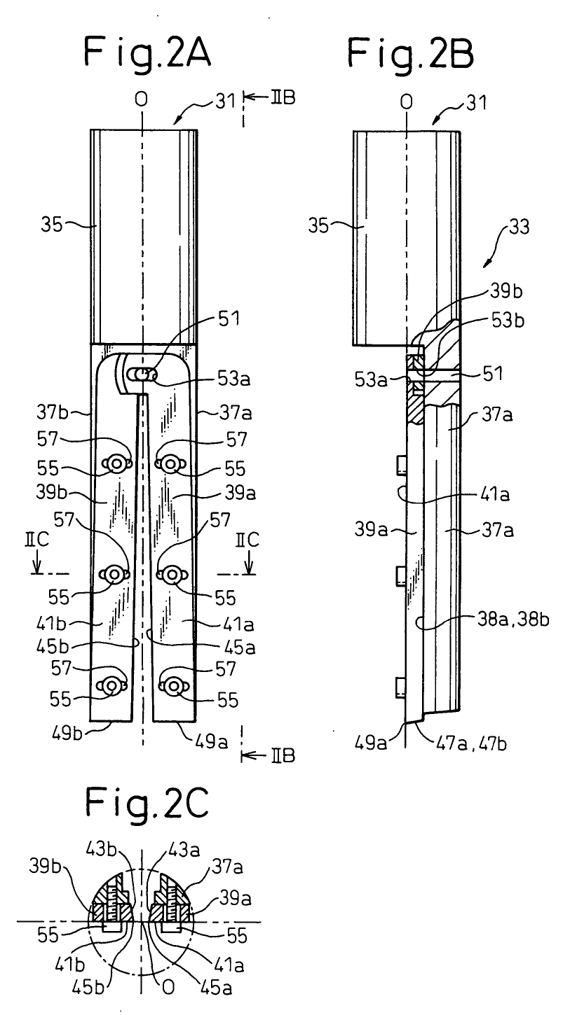

Next, a cutting tool apparatus according to a second embodiment of the present invention will be described with reference to FIGS. 2A to 2C. In FIGS. 2A to 2C, the cutting tool 31 according to the second embodiment includes a cylindrical shank portion 35, and a holder 33 having a pair of arms 37a, 37b provided on axially forward side of the shank portion 35, i.e. on the lower side of the shank portion 35 in FIGS. 2A and 2B. The arms 37a, 37b are formed with blade mounting surfaces 38a, 38b, respectively, for mounting thereon blades 39a, 39b forming the cutting portions. The blades 39a, 39b are in turn formed with a plurality of slots 57 extending substantially transversely. The blades 39a, 39b are fixed on the arms 37a, 37b by screwing fixing bolts 55 into the internal screws formed at the corresponding portions of the arms 37a, 37b. Thus, the blades 39a, 39b are coupled to the shank portion 35 through the arms 37a, 37b.

The blades 39a, 39b have rake faces 41a, 41b, first flanks 43a, 43b and second flanks 47a, 47b similar to those of the cutting tool 11 according to the first embodiment. The rake faces 41a, 41b and the first flanks 43a, 43b make up first cutting edges 45a, 45b. The rake faces 41a, 41b and the second flanks 47a, 47b make up second cutting edges 49a, 49b. The second cutting edges 49a, 49b extend substantially transversely with respect to the center axis O as viewed from the front side of the cutting tool 31. The first cutting edges 45a, 45b, like in the first embodiment, extend linearly and in parallel to each other or extend linearly or curvedly in such a manner as to converge from the forward end toward the base end along the center axis O. The first cutting edges 45a, 45b are mounted in a fork-shape in opposed relation to each other.

In this embodiment, as described above, the blades 39a, 39b are mounted removably on the holder 33, and therefore both the first cutting edges 45a, 45b and the second cutting edges 49a, 49b can be easily re-ground. In view of the fact that bolt holes 57 are formed as slots extending substantially transversely of the blades 39a, 39b, the width and angle between the first cutting edges 45a, 45b can be adjusted. Specifically, the shape of the cutting edges 45a, 45b can be adjusted in accordance with the thickness and gradient of the rib portion. Incidentally, the operating of cutting the workpiece W by means of the cutting tool 31 according to the second embodiment is substantially same as in first embodiment and therefore is not be described in detail.

Further, a pin 51 is fixed at a portion adjacent to the base end portion or the shank portion 35 of the arms 37a, 37b, and slots 53a, 53b extending substantially transversely of the blades 39a, 39b are formed, as pin holes, at the base end portion of the arms 37a, 37b. The engagement between the pin 51 and the slots 53a, 53b facilitates the positioning of the blades 39a, 39b with respect to the arms 37a, 37b. In the mounting of the blades 39a, 39b, a positioning member (not shown) is arranged as required between the blades 39a, 39b, thereby further facilitating the positioning of the blades 39a, 39b with respect to the arms 37a, 37b. In the case where the blades 39a, 39b and the blade mounting surfaces 38a, 38b are formed such that the rake faces 41a, 41b extend along the center axis O of the cutting tool 31 or the rake faces 41a, 41b contain the center axis O, the programming for C-axis controlling of the spindle 11 can be facilitated.

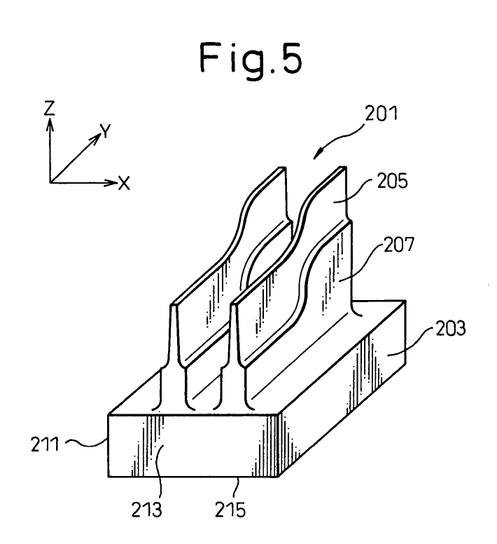

Next, with reference to FIG. 5, a rib electrode for electric discharge machining according to an embodiment of the present invention will be described. The rib electrode for electric discharge machining 201 is configured of a base portion 203 and rib portions 205 formed integrally with each other. Each of the rib portions 205 has a reinforcing portion 207 at the base thereof adjacent to the base portion 203. The rib portions 205 are formed to extend in parallel or tapered toward the forward end in a direction of the thickness thereof, and to extend linearly or curvedly in a direction of the length thereof. The two rib portions 205 of the rib electrode shown in FIG. 5 are erected in parallel to each other, and have the height changing in Z-axis direction with respect to the Y-axis position.

The base portion 203 has an X-axis reference surface 211, a Y-axis reference surface 213 and a Z-axis reference surface 215. The reference surfaces 211, 213, 215 are machined in advance on an electrode material. During the machining of the rib portions 205, with reference to the reference surfaces 211, 213, 215, the rib portions 205 are machined roughly by means of a rotary cutting tool such as a ball mill or a ball-end mill, and then finish-machined by means of the cutting tool apparatus according to the present invention. For the rib electrode 201 shown in FIG. 5, this cutting operation is performed by moving the cutting tool in the direction along Y-axis, i.e. along the machining path from the near side to the far side, while controlling the height in the direction along Z-axis.

Although the preferred embodiments have been described above, it would be apparent to those skilled in the art that the present invention is not limited to the aforementioned embodiments and various changes and modifications can be made.

In the embodiments described above, the table 107 of the cutting apparatus 101 is adapted to be able to move in the X-axis and Y-axis directions in a horizontal plane. However, the present invention is not limited to this configuration, but the table 107 may be adapted to be able to move in one of X-axis and Y-axis directions and the column 103 may be adapted to be able to move in the other direction. Also, in the cutting apparatus 101 according to the embodiments described above, the workpiece fixed on the table 107 and the cutting tool mounted at the forward end of the spindle 111 can be moved relative to each other in the three orthogonal directions and C-axis direction about the spindle 111. However, the present invention is not limited to these embodiments. In the cutting apparatus 101, the workpiece fixed on the table 107 and the cutting tool mounted at the forward end of the spindle 111 may be moved relative to each other at least in the Z-axis direction parallel to the spindle 111, the C-axis direction about the Z-axis and one of the X-axis and Y-axis directions. In this case, the cutting apparatus 101 can machine a thin tabular rib portion R extending along a straight line as shown in FIGS. 1A to C. Further, the Z-axis of the machine tool 101 may be not vertical as shown in FIG. 3, but the spindle 111 of the machine tool 101 may be configured to extend in a horizontal direction.

Also, in the foregoing description, the first cutting edges 23a, 23b and 45a, 45b extend in parallel to each other or are formed in such a manner as to progressively diverge from the base end side toward the forward end along the center axis O. However, the present invention is not limited to this configuration, and one of the first cutting edges 23a, 23b or 45a, 45b may be formed to extend in parallel to the center axis O and the other progressively extend away from the center axis 0 in the direction from the base end side toward the forward end. In other words, the first cutting edges 23a, 23b or 45a, 45b are not necessarily symmetric with respect to the center axis O. In short, they may have a shape corresponding to the shape of the rib portion of the workpiece to be machined. The cutting edge is not limited to two pronged shape and may be formed in three pronged shape. One side of the rib portion may be cut at one time, using cutting edges spaced at a slightly larger interval rather than cutting edges spaced at the same interval as the thickness of the rib portion. Also, the second cutting edges 25a, 25b and 49a, 49b are not necessarily symmetric with respect to the center axis O and may be formed to conform to the required shape of the workpiece W, especially to the shape of the upper surface of the base portion B. The intersection between the first cutting edges 23a, 23b or 45a, 45b and the second cutting edges 25a, 25b or 49a, 49b may be chamfered or formed in an arc shape having a predetermined radius.

In the embodiments described above, the workpiece W has a rib portion R projected in form of a tabular wall from the base portion B. However, the present invention is not limited to this configuration, and the rib portion R may have any of various forms. In the workpiece W shown in FIG. 4, for example, the rib portion R projected from the base portion B is curved in an S-shape. The height of the rib portion 205 of the rib electrode 201 shown in FIG. 5 is changed in the Z-axis direction with respect to the position in the Y-axis direction. The rib portion R of this shape can be machined by controlling the C- and Z-axes of the cutting apparatus 101. Incidentally, the material of the workpiece W may be any of graphite, copper, aluminum, cast iron and steel.

1. A method for cutting a rib portion of a workpiece, said method comprises steps of:
determining a shape of a cutting edge of a cutting tool so as to be of a shape corresponding to a cross section of a rib portion to be machined;
mounting said cutting tool on a spindle of a machine tool; and
moving said cutting tool relative to said workpiece along a machining path extending in a longitudinal direction of said rib portion to be machined to thereby cut said rib portion of said workpiece to a desired shape.

2. A method for cutting a rib portion of a workpiece, said method comprising steps of:
preparing a cutting edge of a cutting tool so as to be of a shape corresponding to a cross section of a rib portion to be machined;
roughly machining said rib portion of said workpiece with a rotary cutting tool and then mounting said cutting tool on a spindle of a machine tool; and
moving said cutting tool relative to said workpiece along a machining path extending in a longitudinal direction of said rib portion to be machined, while at the same time controlling a rotational angle of said spindle such that the front side of said cutting edge of said cutting tool is always maintained at right angle to the forward direction of the machining path, to thereby finish-machine said rib portion to a desired shape with said cutting tool.

3. A cutting apparatus for cutting a rib portion of a workpiece, said cutting apparatus comprising:
a spindle for mounting thereon a cutting tool for machining a workpiece;
a table for fixing said workpiece thereon;
a feed unit for moving said spindle and said table relative to each other; and
a cutting tool having a two-pronged cutting edge of a shape corresponding to a cross section of said rib portion of said workpiece to be machined,
wherein said two-pronged cutting edge is engaged with both side surfaces of said rib portion to be machined, and said cutting tool is moved relative to said workpiece along a machining path extending in a longitudinal direction of said rib portion to thereby cut said rib portion.

4. A cutting apparatus for cutting a rib portion of a workpiece, said cutting apparatus comprising:
a cutting tool having a two-pronged cutting edge of a shape corresponding to a cross section of said rib portion of said workpiece to be machined;
a spindle for mounting thereon said cutting tool for machining said rib portion of said workpiece and capable of being controlled in a rotational angle;
a table for fixing said workpiece thereon; and
a feed unit for moving said spindle and said table relative to each other in three directions along X-, Y- and Z-axes,
wherein said two-pronged cutting edge is engaged with both side surfaces of said rib portion to be machined, and said cutting tool is moved relative to said workpiece along a machining path extending in a longitudinal direction of said rib portion while, at the same time, controlling a rotational angle of said spindle such that the front of said cutting edge of said cutting tool is always maintained at right angle to the forward direction of the machining path, to thereby cut said rib portion.

5. A cutting tool apparatus mounted on a machine tool for cutting a rib portion of a workpiece, said cutting tool apparatus comprising:
a shank portion mounted on said machine tool;
a cutting portion located axially in front of said shank portion; and
a two-pronged cutting edge provided on said cutting portion and extending in a shape corresponding to a cross section of said rib portion to be machined.

6. A cutting tool apparatus mounted on a machine tool for cutting a rib portion of a workpiece, said cutting tool apparatus comprising:
a shank portion mounted on said machine tool;
a pair of arms having a fork-shape and located axially in front of said shank portion; and
blades mounted on said arms such that an interval and/or angle of said cutting edge can be adjusted in accordance with a cross section of said rib portion to be machined.

7. A rib electrode for electric discharge machining mounted on an electrode holder of an electric discharge machine, said rib electrode comprising:
a base portion having a reference surface for contacting with a reference portion of said electrode holder for holding said rib electrode and mounted on said electrode holder; and
a rib portion projected from said base portion and cut by means of a cutting tool having a two-pronged cutting edge of a shape corresponding to a cross section of said rib portion to be machined with reference to said reference surface of said base portion,
wherein the shape of said rib portion is roughly machined with a rotary cutting tool and then finish-machined with said cutting tool.
